(19) United States
(12) Patent Application Publication
(10) Pub. No.: US 2015/0294319 A1
(43) Pub. Date: Oct. 15, 2015

(54) System and method for assuring a correct performance of a manual operation

(71) Applicants: Knut Are Dyrdal, Bekkjarvik (NO); Arne Roald, Jar (NO)

(72) Inventors: Knut Are Dyrdal, Bekkjarvik (NO); Arne Roald, Jar (NO)

(21) Appl. No.: 14/408,242

(22) PCT Filed: Jun. 14, 2011
(86) PCT No.: PCT/NO2011/000172

§ 371 Date: Feb. 15, 2015

(30) Foreign Application Priority Data
Jun. 14, 2010 (NO) 20100846

(51) Int. Cl. G06Q 30/00; H04W 4/00; G01P 3/00; G01B 21/00; G01M 99/00

(52) U.S. Cl. CPC G06Q 30/018; G01B 21/00; G01M 99/005; G01P 3/00; H04W 4/005

(57) ABSTRACT

A system is disclosed that ensures the proper execution of a manual operation of an equipment according to a procedure, including a measuring device mounted in association with the equipment, the measuring device being adapted to measure a condition of the equipment before, during and after the execution of the operation on the equipment, a micro-transmitter attached to the measuring instrument, which wirelessly sends the measurement value and the changes of the measurement value caused by the operation, the micro transmitter's identity and position to a communicator, the communicator being adapted to verify the received data against the expected state of the equipment according to the procedure, wherein the procedure is stored in the communicator or transferred from a system computer to the communicator, a discrepancy between expected state and measurement data triggering an alarm in the communicator or in other equipment that the operation is not executed according to the procedure.

### FIELD OF THE INVENTION

The present invention relates to a system and method for safe execution of manual operation on equipment according to operational procedures, and applications of this system

### BACKGROUND

Several safety critical work processes, which include manual operations or manual operations as part of an automated process, are characterized by a person (the operator) performing one or more manual operations, for example operating manual valves at the start of the process, based on a set of procedures and where it can be critical for the safety of the plant or equipment that the operations are performed in exactly the right order. In order to perform the operation the operator must visually identify the equipment to be operated and tool that he will use. The operator must also continuously determine equipment status (open/closed) and read process values such as pressure and temperature on the local visual instruments.

Another type of work process is characterized by regular inspection of equipment by the operator according to work plan. The operator observes and/or records the condition of the equipment and the measured values from local process measuring instruments. The observations are compared with documented requirements and specifications for the operation of the equipment and process.

A third type of work process is troubleshooting on equipment or systems where the operator wants direct assistance from specialists in operation centers or from the equipment supplier to locate the problem and decide further action. Today the first phase of identifying the problem can be time consuming because the operator must communicate over telephone to the remote specialists in order to give a detailed snapshot of equipment and facilities. This communication may sometimes be difficult because of the high noise level in the process area.

An important part of all these work processes are to observe the status and changes to equipment and process variables from local instruments.

For all these work processes, the unambiguous identification of the equipment and operating order in relation to the procedure is important, and in some cases quite critical since the activation of the wrong equipment can increase the risk of accidents.

Today, the operator identifies the equipment visually using the nameplate; the work is normally done from the notes, or memorized routines. Equipment status and measurement values are observed visually. Confirmation of the completion of these operations may only be notes in the operator's logbook. In addition, many of the operations may be coordinated with operators in far away control rooms. The noise level in the plant may be high, so even if the communication is by radio, it is difficult and time consuming to make sure that the “agreed activity” will be performed.

Equipment for electronic verification of these type of work processes are currently either unavailable or too expensive to procure/install/operate in relation to the total price of the industrial plant, and therefore is not installed. This means that a number of operations that must be done “right”, in “correct order” and/or “on time” have no other proof than verbal or written confirmation by the operator that the work is performed.

In coordinated operations, also referred to as “Integrated Operation”, the various operators taking part in the coordinated operations will be located on geographically separated locations. In the Oil and Gas industry, one of the challenges in Integrated Operations is for groups of specialists in operation centers to follow the real operations done in the field communicating on radio with field operators (for example startup after maintenance work). Additionally, the voice communication over radio is complicated by high noise levels in the plant.

In a troubleshooting process, an operator on a platform, on a ship or the like may communicate with an equipment specialist from a supplier and/or an expert in an operation center onshore. In such cases it is vitally important that all parties know which equipment they “operate” on as well as the state of the particular equipment.

Within a range of industries such as oil and gas industry, process industry, food, retail, water treatment, purification, heating and refrigeration systems (for example, cleaning of cooling towers), passenger transport, cargo transport, medical services etc. there are a number of opportunities to make mistakes, or failure to do the job at all. If there is an issue, this will be discovered later when a hazardous event occurs because of the error not being discovered during the performance of the work.

### SUMMARY

It is an object of the present invention to provide a system for independent computer-aided verification of manual operations and process measurements in accordance with approved work procedure so that the work is carried out safely and that all equipment operates within all the requirements and specifications that are set for operation of equipment and facility. In addition, all steps in the work operation are documented.

A further object of the invention is to provide a system, which to a greater extent than today's systems, allows the operating organization to be notified when time-critical or condition-critical maintenance processes shall be implemented according to plan. It also provides the operator and the control center operator and specialists with the opportunity to prepare for the present job including reviewing and possible revising of work procedures, assisting the operator to find the equipment in the plant in the sequence determined by the work procedure and carrying out the work safely, possibly in collaboration with specialists in the control center for the operation.

A further object of the invention is an “electronic registration and storage” of data from visual inspection that the operator has performed in accordance with the procedure, at the right time and order, together with the said manual verification of manual operations and process measurements. This may for example be the presence and control of technical condition of road- or rail-vehicles, general cargo security at transport, or government-imposed controls of cooling towers and temperature/purity control in the food industry.

A further object of the invention is that the system can guide the operator through the shortest path to the equipment in the plant by reading the electronic data from fixed information devices or from micro-transmitters (4) and at all times knows where the operator is in the plant and guide him to find the equipment.

A further object of the invention is to ensure that the deviation of a continuous measurable condition is identified as soon as the deviation exceeds the allowable limits that are set. This may for example apply to cargo fastening or placement of equipment and the like.

These objects are achieved by a system for computer-aided verification of the work, which consists of micro transmitters (4), communicators, data transmission, computers and operating software for use in the system, as shown by the subsequent patent claims.

### BRIEF DESCRIPTION OF THE DRAWINGS

The invention will now be described in detail by reference to the attached drawings, in which:

FIG. 1 is a schematic overview of the inventive system

FIG. 2 shows an application of the system for securing cargo,

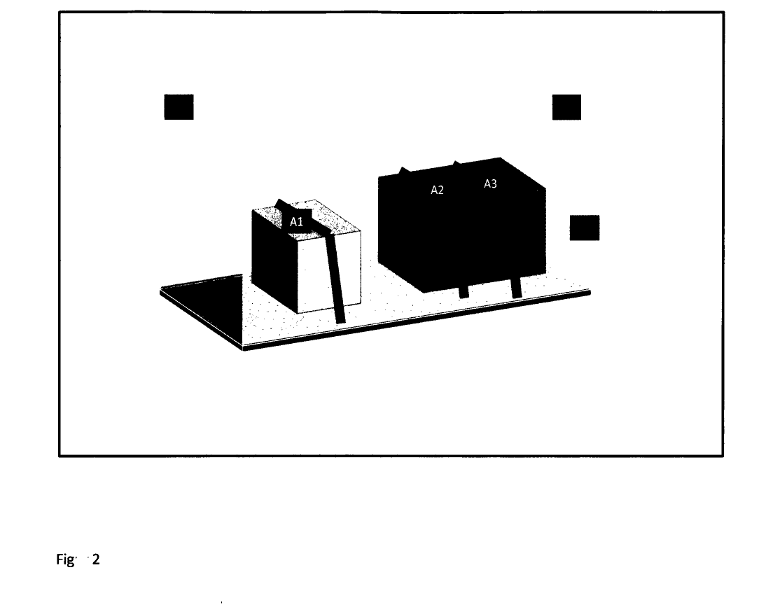

FIG. 3 shows an application of the system for electronic placement and retrieval of objects.

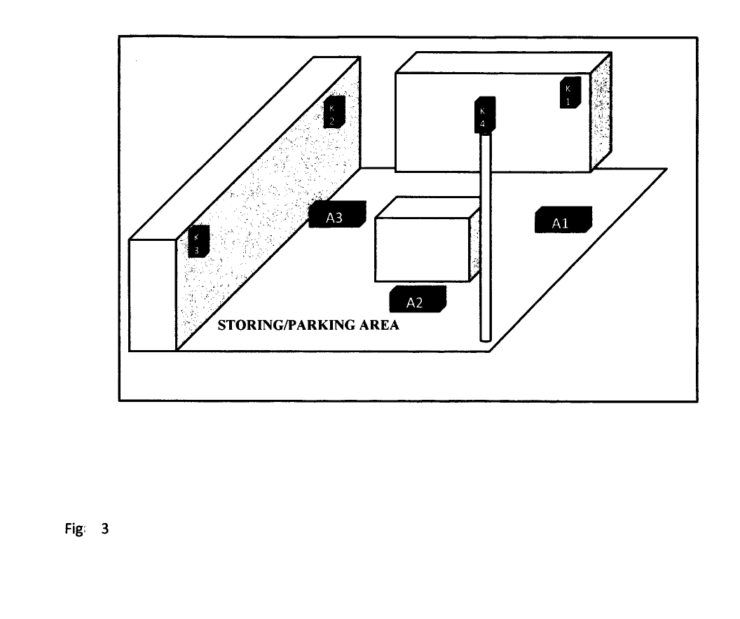

### DETAILED DESCRIPTION

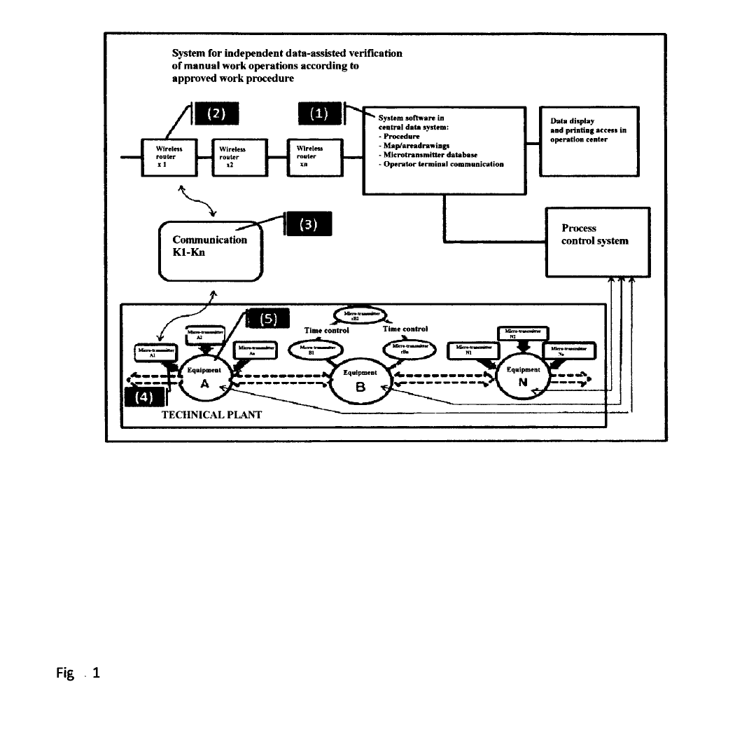

The invention will now be described with reference to the drawing FIG. 1 which shows a schematic overview of the various technical components of the system according to the invention

The system according to the present invention includes micro-transmitters A1-Nn (4) mounted on equipment A-N (5) (micro-transmitters Al to An of equipment A, B1 to Bn in the equipment B, etc.), in the technical plant, portable communicators K1-Kn (3), wireless data networks 1-n (2) that provides bi-directional data between the communicator (3) and system software that is installed in a central computer system or system computer (1).

In the first phase of the work operation the required data and procedures from the central system (1) are transferred to the communicator (3). Communicator (3) assists the operator to find first equipment A and micro-transmitter (4) to be operated as specified in the procedure.

In process plants within partially enclosed areas, the start and access route will be displayed on map or site drawings on the communicator (3) from a start position which is transmitted from fixed location sensors installed in the plant or from GPS to the communicator (3) to the destination at equipment A.

Where technical facilities are installed on a movable device such as car, train, rail, etc. and the verification is carried out in different geographic locations, GPS position from the hand terminal is used to document were the geographic verification is performed. Micro-transmitters may also contain position identifiers as GPS or similar, where the position is one of the variables that are monitored by the system

When the operator has reached the equipment A, it is identified by micro-transmitter (4), which is mounted on the equipment and activated by the wireless communicator (3). Micro-transmitter (4) responds by transmitting its own identity to the communicator (3) and on to the system software. Micro-Transmitter (4) may also be able to show a visual light signal to the operator that it is activated by the communicator (3).

Micro-transmitters (4) send their own identity, the identity of equipment (5), measured process values (pressure, temperature, level, current, voltage, resistance, field strength, power, energy, vector power, position, velocity, acceleration, operating status (on/off, running time, etc.), equipment status, name of the process value, other necessary processing equipment data, and calculated derivative values of the equipment (5) to the communicator (3) and on to the system software in the central computer system or the system computer (1).

Micro-transmitters (4) may also store process measurements and equipment condition data over time so that statistical data and limit values can be extracted when the operator activates the micro-transmitter (4) with communicator (3) and stores the data in the system software.

Normally the micro-transmitter (4) receives energy, both for communication and measurement, transmitted from a portable communicator (3). In the case where continuous energy supply is needed, this may come from a built-in energy source based on vibration, light or electromagnetic induction, or from a fixed radio terminal in the area also referred to as “parasitic” energy. This energy is stored in the micro-transmitter (4) and used when needed.

Micro-transmitters (4) may include a local indicator for displaying the measurement status and/or alarm limit.

Several micro-transmitters (4) on the equipment (5) may be in the same work operation, or they can follow in sequence as described in the procedure. Equipment data and status are automatically or manually checked against the procedure to ensure that the operator has selected the right equipment and process conditions (pressure measurement, valve status, etc.).

Operations such as “can not be measured” can also be verified and substantiated by the operator confirming on the communicator that he has been in the right position at the right time and long enough and by this action has taken responsibility that the operation has been performed.

Communicators (3) transmit, continuously or on command from the operator, all data from the micro-transmitters via the wireless network to the software in a computer system (1). Data is displayed on monitor (s) in operation centers so that specialists can monitor the work. Communicator (3) can have a camera and transfer images of equipment when this is desirable. The operator of the facility and specialists in the operation centers may also communicate via radio.

The operator will now follow the online procedure as shown on the communicator (3). When the communicator (3) confirms the correspondence between the procedure and recorded identity, the operator acknowledges this using the communicator (3). Alternatively, it may be confirmed by the fact that the activity is carried out within a time window. He then proceeds through the work process step by step as shown in the online procedure on the communicator (3). The procedure which includes the activities verified by the communicator may also reside in the central data system (1) to which the communicator may be connected online. This may be both manual operation of equipment (5) and/or to read process data/equipment status sent wirelessly from micro-transmitters (4) to the communicator (3). Other equipment/process data needed for safe operation is transferred from the permanently installed process control system via the system software and displayed on the communicator (3). Any calculations to support the operator in the work process are done electronically and displayed on the communicator (3). For each step in the procedure the communicator (3) performs automatic comparison between the status of equipment (5) and expected status in relation to the electronic procedure. When this control is approved, the next step in the online procedure starts and is displayed on the communicator (3). When the work operation of equipment (5) is completed, the operator confirms on the communicator (3) and proceeds to the next equipment (5), or finishes the work.

In the operation of safety critical processes, the system can be combined with the operation of equipment via a permanently installed control system. This may contribute to increased safety as the system is based on different technology and is physically independent of the permanent control system. The fact that the system can be an independent system may also help the plant get a higher security class (SIL), which can have both beneficial financial and staffing effects.

The procedure is arranged so that multiple operators can use several communicators (3), and perform independent manual operation sequences. The procedure is common for the entire operation ensuring operations that cannot lead to dangerous situations.

This ensures that the operator during the execution of a number of safety-critical processes gets verification and documentation for every step of the work operation before it is executed and after it is completed, and that the operator can be stopped/corrected if the work is attempted to be executed in the a wrong way, in the wrong order, in the wrong time or without sufficient preparation, etc.

Post inspection of an operation (such as cargo security during the transport) can be performed and documented in a simple manner.

In applications of the system equipment (5) or where the equipment (5) changes, a “procedure generator” may be part of the system computer program, so that the operator by use of the communicator (3) accesses the micro-transmitters (4) one by one, and add in new operations and measurements, which in term is transmitted from the communicator (3) and stored as a new revision of the procedure in the system computer program

Micro-transmitters (4) for a wide range of measurements have low production cost and no removable battery, which ensure that the Life Cycle Cost (LCC) is extremely low. This enables measurement and verification of manual operations in the work processes that are currently not possible.

1. A system to ensure proper execution of a manual operation on equipment (5) according to a procedure, comprising a measuring device mounted in association with the equipment (5), as the measuring instrument is designed to measure a condition of the equipment before, during and after the execution of the work operation of the equipment (5),
characterized in a micro-transmitter (4) associated with the measuring instrument, which wirelessly sends the measurement value and the changes of the measurement value resulting from the working operation, micro-transmitter identity and position of a communicator (3), where the communicator (3) is adapted to verify the received data against the expected equipment condition, according to the procedure, wherein the procedure is stored in the communicator (3) or transferred from a system computer (1) to the communicator (3), if a discrepancy between expected state and the measured data providing an alarm on the communicator (3) or other equipment that the work operation is not performed in accordance with the procedure.

2. A system according to claim 1, where the communicator (3) is adapted to provide directional instructions to the next equipment in that it identifies its position and provides photo or map indication of the direction to the next equipment.

3. A system according to claim 1, where operations that cannot be measured, are verified by one or more of the following variables as the correct order according to the procedure, the presence at a position and on time and within set time frames acknowledged for execution by an operator on the communicator (3).

4. A system according to claim 1, where all the necessary electrical energy for operating the micro-transmitter is supplied wireless electromagnetically (radio waves, inductive, etc.), optically (light energy, etc.), electrically via a process connection or generated internally by means of external kinetic energy transferred through the process connection (pneumatic, hydraulic or mechanical) or the natural movement of the equipment (5) the micro-transmitter (4) is mounted on, or by energy that has been present over a given time that can be stored within a battery or a capacitor or other media for use when needed.

5. A system according to claim 1, where the communicator (3) is arranged to receive position data from GPS or other systems for positioning, or other wireless location data as passive RFID from fixed location references, or by comparing signals from adjacent micro-transmitters (4) to determine their own position.

6. A system according to claim 1, where the communicator (3) is arranged so that all communication with the micro-transmitter (4) and computer system (1) is secured against unauthorized use.

7. A method which ensure a proper execution of a manual operation of a device according to a predetermined procedure;
characterized in that the procedure involves the following steps: measuring at least one condition of the equipment before, during and after the execution of the work operation,
transmission of data for measuring values, identity and position of the equipment to a communicator (3),
verification of data against an expected state of equipment in accordance with the predetermined procedure, when a discrepancy between expected state and the measured data provides alarm on the communicator or other equipment that the work operation is not performed in accordance with the predetermined procedure.

8. A method according to claim 7, where the alarm is transmitted to other communicators (3) and the system computer (1).

9. A method according to claim 7, including the additional steps to identify the communicator's (3) position and gives directions to the next equipment.

10. A method according to claim 7, where the communicator's (3) position is identified by receiving positional data from GPS or other systems for positioning, or other wireless location data as passive RFID from fixed location references, or by comparing signals from micro-transmitter (4) in the vicinity.

11. Use of the system according to claim 1 to verify that the manually performed operations are conducted in accordance with approved procedures before a vehicle or train or boat is used for transport purposes.

12. Use of the system according to claim 1 for the control of conveyance such as vehicle or train or boat, including
information about movement, time, position and temperature and other measured variables as well as image and/or video recording at programmed time or place or when it is outside the accepted zone, speed or movement is recorded and stored,
the measuring equipment and micro-transmitter (4) attached to the transport measures and transmits position and tension and vibration to the communicator (3),
the communicator (3) verifying data in accordance with the procedure and forward deviations to the system computer (1) forwarding an alarm about deviations to a control center.

13. Use of the system according to claim 1 for the control of vehicles, including
that it is used to regularly verify the operational data from the wheels, axles and brakes etc from measuring equipment that is permanently mounted on the vehicle in motion,
that micro-transmitters (4) record measurement data periodically and transmit it wirelessly to communicators (3) that are permanently located at fixed crossing points or operated by an operator at fixed stops for vehicles,
that the communicator(s) (3) verifies the data according to the procedure and forwards deviations to the system computer which forwards an alarm about the deviation of a control center, and to the driver of the vehicle.

14. Use of the system according to claim 1 for electronic location and retrieval of vehicles and other equipment that is equipped with measuring equipment and micro-transmitters (4) and optionally a system for settlement of the cost of such location/parking and that the communicator(s) (3) can also monitor the unauthorized removal of equipment, as the:
communicator(s) (3) will send out location information to a mapping software or receive GPS information and provide its exact position to the mapping software in the computer,
communicator(s) (3) will send out location information in the same way as satellites in the GPS system,
communicator(s) (3) transmits the data on the wireless/wired computer network to the computer system (1),
computer system (1) dynamically registers all micro-transmitters (4) with its own ID and location information.

15. Use of the system according to claim 1 for the control of cleanliness, hygiene and condition, including measurements with micro-transmitters (4) and
observations in accordance with the procedure and planned time intervals are performed and the verification is transmitted to a follow-up system.

16. Use of the system according to claim 1 for monitoring the sealing of the packaging used once or multiple times for the shipment of goods such as medicine or other components to ensure prevention of confusion or loss of the contents during transportation, including:
that one or more micro-transmitter (4) mounted on the packaging register a digital coded identification of one or more seals after they are used to seal the container,
that an operator uses a communicator (3) to transmit the digital ID from the sealing to the micro-transmitter(s) (4), together with other data relating to the shipment as content, sender, recipient and time information stored in the micro-transmitter in the packaging,
that the same information stored in the micro-transmitter(s) (4) are transmitted wirelessly to the computer system (1) from the communicator (3),
that the digitally encoded information in the micro-transmitter(s) (4) are read at the receiving point of shipment with a communicator (3), and compared with stored information from the transmitter site in the system computer (1),
that the operator observes that the seal of the packaging is unbroken and intact.
